(19) United States
(12) Patent Application Publication
(10) Pub. No.: US 2026/0257964 A1
(43) Pub. Date: Sep. 3, 2026

(54) FORMULATION FOR THE PREPARATION OF OPTICAL METAL OXIDE LAYERS

(71) Applicant: Merck Patent GmbH, Darmstadt (DE)

(72) Inventors: Roy Schreiber, Rehovot (IL); Andreas Berkefeld, Darmstadt (DE); Odelia Saadon, Mevasseret Zion (IL)

(21) Appl. No.: 19/159,953

(22) PCT Filed: Mar. 21, 2024
(86) PCT No.: PCT/EP2024/057541

§ 371 Date: Aug. 26, 2025

(30) Foreign Application Priority Data
Mar. 24, 2023 (EP) 23163964.2

(51) Int. Cl. C03C 17/25; G02B 1/10; G02B 5/18

(52) U.S. Cl. CPC C03C 17/25; G02B 1/10; G02B 5/1847; C03C 2217/228; C03C 2217/23; C03C 2218/116; C03C 2218/32

(57) ABSTRACT

The present invention relates to a formulation for preparing an optical metal oxide layer.

### FIELD OF THE INVENTION

The present invention relates to a formulation for preparing an optical metal oxide layer comprising one or more metavanadate salts, use of the formulation, a method for preparing an optical metal oxide layer and an optical device comprising an optical metal oxide layer. Said formulation and method according to the invention are particularly suitable for the preparation of metal oxide optical layers for optical applications or devices such as, for examples, diffractive gratings for augmented reality (AR) and/or virtual reality (VR) devices. The metal oxide layers show (a) favorable optical properties such as high refractive index (RI) of >1.6, preferably >2.0, at wavelengths of ≤520 nm and/or low absorption of <0.5% at 480 nm, and/or low degree of haze formation; (b) favorable mechanical properties such as low shrinkage; (c) favorable coating properties such as dense layer and flat surface structure; and/or (d) favorable filling properties such as homogeneous filling of topographical features on patterned substrates.

The embodiments of the present invention allow the preparation of optical metal oxide layers on the surface of both patterned and non-patterned substrates. The metal oxide layer may form various structures such as, for example, layers covering a surface of a non-patterned substrate and/or fillings covering topographical features such as e.g. gaps on the surface of a patterned substrate, thereby providing highly refractive optical structures. In particular, the embodiments of the present invention allow the preparation of advanced optical gap filling with low overburden, thus enabling an easy and cost efficient mass production of complex optical devices by avoiding typical problems occurring when layer deposition or gap filling is performed by physical vapor deposition (PVD) or chemical vapor deposition (CVD) techniques such as, for example, incomplete or excessive gap filling due to unfavorable deposition and layer growth characteristics such as, for example, decreased or increased deposition or growth rates at corners and edges.

The embodiments of the present invention are particularly suitable for the preparation of optical metal oxide layers having high refractive index for optical devices such as, for example, for diffractive gratings in AR and/or VR devices.

Finally, the present invention provides an optical device, preferably an AR and/or VR device, comprising an optical metal oxide layer, which is obtainable by the method according to the present invention or which is prepared by using the formulation according to the present invention.

### BACKGROUND OF THE INVENTION

Vanadium pentoxide, V₂O₅, has a refractive index of n=2.8. Despite this, vanadyl compounds have only been investigated sparsely as high refractive index materials due to a strong absorption in the visible region that leads to a strong red or orange color. In most cases, vanadium in vanadyl compounds adopts either of two coordination geometries. The octahedral coordination, which prevails in most polyoxometalate compounds as well as in vanadium pentoxide, gives the vanadyl compounds their red color making these compounds unattractive for transparent applications.

Leading edge optical devices typically include optical gratings made from composite materials having a substrate as a support and complex and interlaced patterns thereon, the patterns being made up of different layers or stacks of layers. Usually, the creation of such complex and interlaced patterns demands for structuring processes, which become increasingly challenging with decreasing size of structural dimensions to be prepared.

In addition to a wide range of possible uses in various fields of application, such as in spectrometers or in optical storage systems (CD, DVD, etc.), diffractive gratings are the core components of so-called XR devices, mostly glasses. In this context, R stands for the term reality and X denotes different attributes such as, for example, virtual, augmented, mixed and so forth. Hence, diffractive gratings form part of the core of the so-called optical engine in XR devices, specifically in augmented reality and mixed reality glasses. Virtual reality glasses, when built as a head mounted display, are often composed of a conventional liquid crystal (LC) organic light emitting diode (OLED) display being embedded in the device, and thus do not necessarily require diffractive gratings. In contrast, augmented and mixed reality glasses are designed that way to enable consumers to obtain visual impressions of their environment, at its best as if they would not wear any glasses at all. However, they also make it possible to provide and serve digital information and to also project it into the field of vision of individuals. Additional digital information is gathered from recognizing and analyzing the environment, the individual inspects or takes a look currently at. In order to convey and project supporting digital information into the eyes of an individual, the augmented or mixed reality glasses are equipped with an information supply unit, which is coupled to an optical waveguide system that transports the optically coded supporting information through it directly to the lens of the glasses. Here, the information passes a diffractive grating, which couples the incident light into the lens and splits it according to its angular information and its spectral bands by diffraction. After incoupling of the light, the lens serves as waveguide enabling transport of the light to and into the pupil of an individual. The location of light incoupling is independent of any preferred position and thus of the implication of technical needs. The direction of traversal of light within the lenses is determined by the diffractive grating diffracting or splitting the light. At certain positions in the lens, a second and a third diffractive grating serves for changing the direction of light traversal and thereby enforcing the light to be projected into pupil of the user. The light traversal in the glasses is accomplished by total internal reflection (TIR) of the light, thus bouncing several times between the glass interfaces until reaching another diffractive grating, which changes the internal TIR direction of the light (see FIG. 2). The second and third grating are geometrically aligned in different directions with respect to the first and incoupling grating, e.g. by a certain angular distortion of the longitudinal axis, thus allowing to change the direction of propagation of totally internally reflected light. Needless to say, the lens itself or the material of which lenses are made of shall not be absorbing. Otherwise, the supportive information never reaches the pupil of the user or only with strongly depleted light intensity. The process works regardless of the use of reflection or transmission gratings. Usually, the lenses are equipped with both types of gratings to properly guide the light. It should also be mentioned that there are differences in the optical performance of reflection and transmission gratings, which, however, are of no further interest in the context of the current invention. The basic structure of the gratings is very similar, which is more important at this point.

Nevertheless, there are different designs and structures such as surface relief (SR) or volume phase holographic (VPH) gratings to achieve waveguide. Both types are very similar in appearance. In the simplest case, the gratings are somehow mounted onto the surface of a waveguiding material, here the lens. The grating itself is composed of an array of fine structures, mostly trenches of a first material type Material 01 with a refractive index RI 01, however, not limited thereto. The geometrical shape of the trenches may be manifold, from rectangular, over V-shaped trenches, U-shaped and there like. The width, including structures with different widths, the geometrical form of the trenches, their pitch as well as their depth, including different depths, are specially designed to influence the diffraction pattern of the incident light to be diffracted.

In case of SR gratings (SRGs), the trenches or structures of a first material type (Material 01) having a refractive index (RI 01) are filled by a second material type (Material 02) having a refractive index (RI 02), wherein RI 02 is incrementally different from RI 01 (see FIGS. 1 and 3). For the sake of completeness, it should be mentioned that Material 01 or Material 02 may be composed of a stack of structured layers, each containing a different material composition with different refractive index, stacked on top of each other, thereby forming Material 01 or Material 02 having an effective or graded refractive index RI 01 or RI 02, respectively. Incidentally, the (effective or graded) refractive indices RI 01 and RI 02 depend on the refractive index of the waveguide or the lens from which the glasses are made of. If a glass lens with high refractive index (n03>1.46) is used, the (effective or graded) refractive indices of Material 01 and Material 02 are considered to be higher than that of the lens itself, whereby a RI value of 2.0 can be reached and exceeded. High performance gratings, especially those of SR-type, may be manufactured using standard lithography and deposition techniques known from micro-fabrication such as, for example, the manufacturing of integrated circuits.

Such standard techniques typically include physical vapor deposition (PVD) or chemical vapor deposition (CVD) processes and often suffer from incomplete gap filling due to unfavorable deposition and/or layer growth deposition properties including increased deposition and/or growth rates at corners and edges. Such incomplete gap filling results in the formation of voids within the structures to be filled by the PVD- and CVD-materials. In addition to the formation of voids, the surface of the substrate is covered by a PVD and/or CVD layer that is almost as thick as the maximum depth of the deepest structure to be filled by the deposited gap filling material (see FIGS. 4 and 5). In some applications, however, it may be necessary to expose the surface of the substrate so that it is available for further processing. As a consequence, undesired overburden layers from PVD or CVD need to be removed, for example by chemical mechanical planarization (CMP) without harming the original substrate surface underneath. Although CMP is very well established in the process of manufacturing integrated circuits, CMP is a time consuming and costly process and can be seen as a potential economic drawback for mass production of leading-edge optical devices, particularly the mass production of diffractive gratings. It would therefore be desirable to have a solution for an advanced and cost-efficient manufacturing of optical gratings where gap filling does not require CMP (see FIG. 6).

The present invention addresses various disadvantages of the technologies for preparing optical gratings for leading edge optical devices as described above. The focus here is on improved optical properties, improved mechanical properties, improved coating properties and improved filling properties.

### OBJECT OF THE INVENTION

It is an object of the present invention to provide a formulation and a method for preparing optical metal oxide layers, wherein said metal oxide layers are particularly suitable for optical applications and may be used in optical devices such as, for example, in diffractive gratings for AR and/or VR devices. The obtained optical metal oxide layers show (a) favorable optical properties such as high refractive index (RI) of >1.6, preferably >2.0, at wavelengths of ≤520 nm, low absorption, and low degree of haze formation; (b) favorable mechanical properties such as low shrinkage, (c) favorable coating properties such as dense layer and flat surface structure; and (d) favorable filling properties such as homogeneous filling of topographical features on patterned substrates.

Moreover, it is an object of the present invention to provide a formulation and a method allowing an easy and cost-efficient preparation of optical metal oxide layers.

It is a further object of the present invention to enable preparation of optical metal oxide layers on the surface of patterned or non-patterned substrates. The metal oxide layers may form various structures such as, for example, layers covering a surface of a non-patterned substrate and/or fillings covering topographical features such as, for example, gaps on the surface of a patterned substrate, thereby providing highly refractive optical structures.

Hence, it is an object of the present invention to provide a formulation and a method for preparing optical metal oxide layers, wherein said method allows the preparation of advanced optical gap filling with low overburden, thus enabling an easy and cost-efficient mass production of complex optical devices.

It is a further object of the present invention to provide a method for preparing optical metal oxide layers which avoids typical problems occurring when layer deposition or gap filling is performed by PVD or CVD techniques such as, for example, incomplete or excessive gap filling due to unfavorable deposition and layer growth characteristics such as, for example, decreased or increased deposition or growth rates at corners and edges.

It is an object of the present invention that the metal complex and formulation are particularly suitable for the preparation of metal oxide optical layers having high refractive index and at the same time low absorption (optical loss) for optical devices such as, for example, for diffractive gratings in AR and/or VR devices

Finally, it is an object of the present invention to provide an optical device, preferably an AR and/or VR device, comprising an optical metal oxide layer, which is obtainable by the method according to the present invention or which is prepared by using the formulation according to the present invention, and thereby shows the above-mentioned beneficial effects.

### SUMMARY OF THE INVENTION

The present inventors surprisingly found that the above objects are achieved either individually or in any combination, by formulation for preparing an optical metal oxide layer as defined in the claims. Namely, the formulation comprises at least:
(i) an oligomer of a metavanadate salt, preferably said oligomer is an oligomer of same metavanadate salts or an oligomer of mixture of metavanadate salts, preferably said oligomer is represented by formula (I);

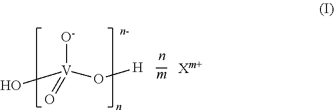

wherein X represents a cation,
m is 1, 2, or 3, preferably 1 or 2,
n is an integer ≥2, preferably between 2 and 10 in water; and
(ii) a formulation medium.

In addition, a method for preparing an optical metal oxide layer is provided, comprising the following steps (a) to (c):
(a) providing a formulation wherein the formulation comprises:
(i) one or more metavanadate salt according to formula (I), wherein X represents a cation, m is 1, 2, or 3, and n is an integer ≥2, preferably between 2 and 10 in water; and
(ii) one or more formulation media; and
(b) applying the formulation on the surface of a substrate; and
(c) converting the formulation on the surface of the substrate to an optical metal oxide layer.

Moreover, an optical device is provided comprising an optical metal oxide layer, which is obtainable or obtained by the method according to the above-mentioned preparation method.

The present invention further relates to the use of the above-mentioned formulation for forming an optical metal oxide layer.

Preferred embodiments of the present invention are described hereinafter and in the dependent claims.

### BRIEF DESCRIPTION OF THE FIGURES

FIG. 1: Schematic cross-sectional view of a SR grating with a Material 01 and a Material 02, wherein the refractive index IR 01 of Material 01 is incrementally different to the refractive index IR 02 of Material 02.

FIG. 2: Schematic cross-sectional view of a SR grating enabling light diffraction (transmissive case) including propagation of diffracted light within waveguide (e.g. lens) by total internal reflection.

FIG. 3: Schematic cross-sectional view of a SR grating providing gaps (trenches) to be filled with a high refractive index material (Material 02), wherein the refractive index of Material 02 is incrementally different form the refractive index of Material 01 flanking the gaps (trenches).

FIG. 4: Schematic representation of PVD- or CVD-mediated gap filling process and removal of undesired overburden.

FIG. 5: Schematic representation of PVD- or CVD-mediated gap filling process creating and leaving voids within gaps and deposited layers.

FIG. 6: Schematic representation of gap filling process using formulations containing inventive metal complex or formulations thereof being converted to metal oxides.

FIG. 7: shows the UV/Vis absorption spectra of the coated fused silica substrate of Example 1.

FIGS. 8A, 8B: show SEM images of the coated trenched silicon nitride substrate of Example 1 showing the trench filling behavior.

FIGS. 9A, 9B: show the UV/Vis absorption spectra of the coated fused silica substrate of Example 2.

FIGS. 10A, 10B: show the UV/Vis absorption spectra of the coated fused silica substrate of Example 4.

FIGS. 11A, 11B: show SEM images of the coated trenched silicon nitride substrate of Example 4 showing the trench filling behavior.

FIGS. 12A, 12B: show the UV/Vis absorption spectra of the coated fused silica substrate of Example 5.

FIG. 13: shows the UV/Vis absorption spectra of the coated fused silica substrate of Example 6.

FIGS. 14A, 14B: shows the UV/Vis absorption spectra of the coated fused silica substrate of Example 7.

FIG. 15: shows the UV/Vis absorption spectra of the coated fused silica substrate of Example 8.

FIGS. 16A, 16B: show the UV/Vis absorption spectra of the coated fused silica substrate of Example 9.

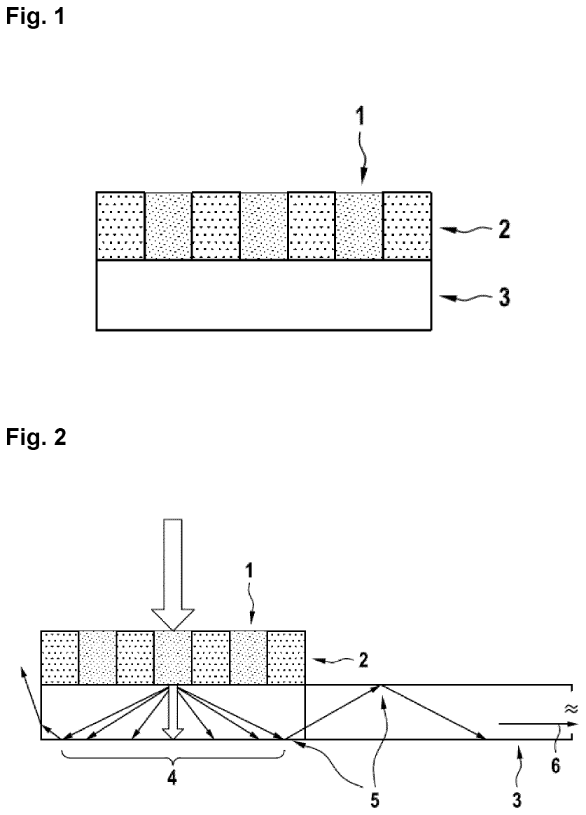

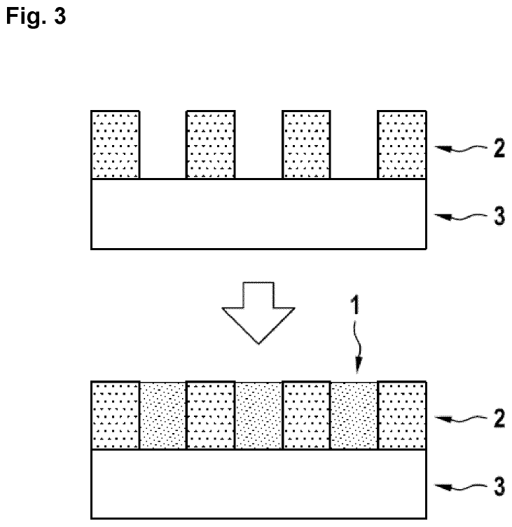

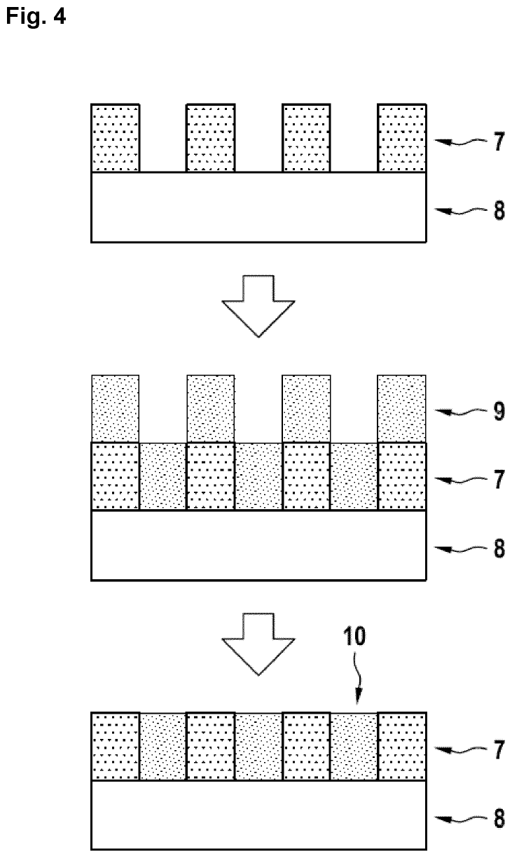

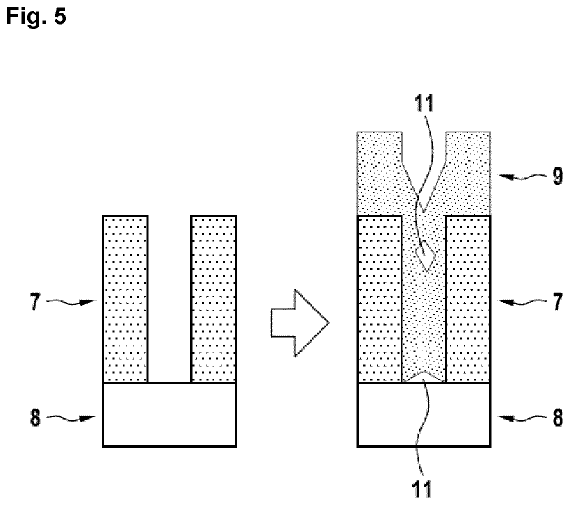

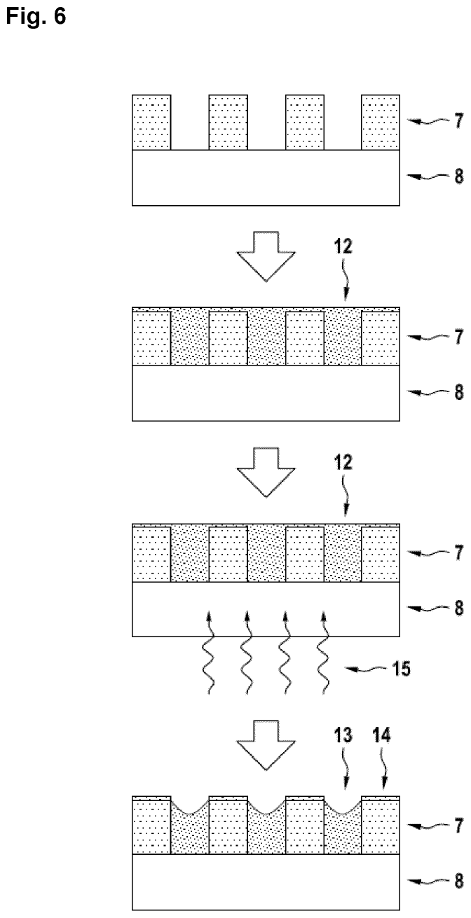

### LIST OF REFERENCE SIGNS

1 Material 02 with RI 02
2 Material 01 with RI 01
3 Substrate (e.g. glass)
4 Diffraction of incident light represented by broad arrow
5 Total internal reflection of light (TIR)
6 Waveguide
7 Structured layer stack with gaps (trenches)
8 Substrate (e.g. glass or silicon)
9 Overburden of material (e.g. high refractive index material or high etch resistant material)
10 Material (e.g. high refractive index material or high etch resistant material) providing gap fill
11 Voids
12 Formulation (e.g. ink) of high refractive index material (e.g. metal oxide precursor)
13 High refractive index material (e.g. metal oxide) providing gap fill with optional concave geometry
14 Overburden layer (optional)
15 Energy

### DETAILED DESCRIPTION

The present invention relates to a formulation for preparing an optical metal oxide layer comprising one or more metavanadate salts, use of the formulation, a method for preparing an optical metal oxide layer and an optical device comprising an optical metal oxide layer.

The present inventors have surprisingly found that meta-vanadate salts may be used for optically transparent, variable refractive index materials that can be processed from aqueous solutions to seamlessly fill trenches of SRG type substrates.

Meta-vanadates are one dimensional (1D) chain structures consisting of a negatively charged [O—V(O₂)⁻]O repeating unit. In aqueous solution of pH 6-10, the 1D chains dissociate into shorter chain oligomers. At lower pH, the formation of octahedrally coordinated polyoxometalate structures predominates whereas a higher solution pH results in formation of the monomeric ortho-vanadate form.

Without wishing to be bound by theory, tetrahedral coordination at vanadium, meta-vanadates lack electronic absorption in the visible spectral region. Dissolution of meta-vanadate salts at controlled pH values leads to short 1D chain oligomers that deposit readily onto trenched substrates. Solvent removal triggers the condensation of oligomeric species to form 1D chains, same as the trenches of the substrate. The compatible dimensionality aids in efficient deposition and organization of meta-vanadates into the trenches in the substrate. Notably, due to their dimensionality, the 1D meta-vanadate chains show negligible tendency to form microcrystalline domains, which reduces undesired light scattering at crystallite boundaries in the material film.

### Definitions

In the context of the present invention, the term “formulation medium” or the plural term “formulation media” as used herein, denote one or more compounds serving as a solvent, suspending agent, carrier and/or matrix for the complex and any other component included in the formulation. Formulation media are generally inert compounds that do not react with said complex and said other components. Formulation media may be liquid compounds, solid compounds or mixtures thereof. A preferred formulation medium contains water.

When numerical ranges herein are indicated using “to”, they include both end points. For example, 1 to 10 means 1 or more and 10 or less.

The term “variable refractive index materials” refers to materials having a refractive index 1.6≤n≤2.2.

The term “surfactant” as used herein, refers to an additive that reduces the surface tension of a given formulation.

The term “wetting and dispersion agent” as used herein, refers to an additive hat increases the spreading and penetrating properties of a given formulation. In this way, the tendency of the molecules to adhere to each other is reduced.

The term “adhesion promoter” as used herein, refers to an additive that increases the adhesion of a given formulation.

The term “coordinating surfactant” as used herein, refers to an additive that coordinates metal ions and acts as a surfactant.

The term “viscosity enhancer” as used herein, refers to an additive that increases the viscosity of a given formulation.

The term “optical device” as used herein, relates to a device containing one or more optical components for forming a light beam including, but not limited to, gratings, lenses, prisms, mirrors, optical windows, filters, polarizing optics, UV and IR optics, and optical coatings. Preferred optical devices in the context of the present invention are augmented reality (AR) glasses and/or virtual reality (VR) glasses.

The term “total amount of metavanadate salt” as used herein means that if there is more than one metavanadate salt then the total amount of metavanadate salt refers to the sum of all the metavanadate salts comprises in the formulation.

If values are given as a range, then it is to be understood that the endpoints are included in the range unless otherwise stated.

### PREFERRED EMBODIMENTS

### Formulation for Preparing an Optical Metal Oxide Layer

In a first aspect, there is provided a formulation for preparing an optical metal oxide layer, wherein the formulation comprises at least:
(i) an oligomer of a metavanadate salt, preferably said oligomer is an oligomer of same metavanadate salts or an oligomer of mixture of metavanadate salts, preferably said oligomer is represented by formula I;

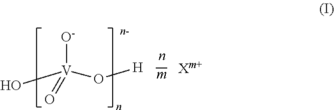

wherein X represents a cation,
m is 1, 2, or 3, preferably 1 or 2,
n is an integer ≥2, optionally n is 2 to 10 when the formulation medium is water; and
(ii) a formulation medium.

Here,

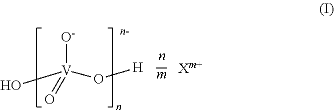

is equivalent to

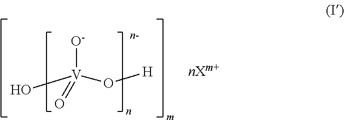

and “n−” in the formula (I) means the total negative charge of

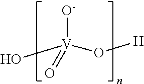

of the formula (I).

Thus, in other words, the formula (I) is equivalent to

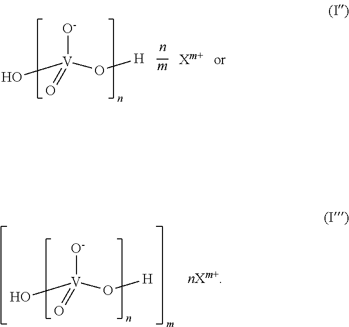

Conveniently, the refractive index of metavanadates may be tuned by changing the relative volume occupied by the counter cation without significantly affecting other physical properties. The introduction of organic counter ions may render the metavanadates compatible with organic solvents, which widens the scope of processability of this class of materials.

In aqueous solutions, the metavanadate salt typically exists as an oligomer, where n is 2 to 10, preferably 2 to 6, while it exists as a polymer in the solid state.

In some embodiments, the cation X is independently of each other, at their occurrence, selected from the group consisting of ammonium cation, alkali metal cation, alkaline earth metal cation, and organic cation. In some embodiments, the cation is an ammonium cation. In some embodiments, the cation is an alkali metal cation, such as, e.g. K⁺, Li⁺ or Na⁺. In some embodiments, the cation is an alkaline earth metal cation, such as, e.g. Ba²⁺, Ca²⁺, or Mg²⁺. In some embodiments, the cation is an organic cation, such as, e.g. a monovalent organic cation or a divalent organic cation. In some embodiments, the cation is NR₁R₂R₃R₄⁺, wherein each of R₁, R₂, R₃, and R₄ is individually selected from H, C₁₋₁₈ alkyl, and C₁₋₁₈ alkyl alcohol. Preferred monovalent organic cations are protonated amines, such as, e.g. [N(C₄H₉)₄]⁺, [H₃N(C₄H₉)]⁺, [H₃N(C₄H₈)NH₃]²⁺, [N(CH₃)₃(C₈H₁₇)]⁺, and phosphonium cations R₁, R₂, R₃, and R₄ is individually selected from C₁₋₁₈ alkyl and C₅₋₆ aryl. a. In some embodiments, the cation is PR₁R₂R₃R₄⁺, wherein each In preferred embodiments, the cation is selected from the group consisting of Li⁺, Na⁺, NH₄⁺, K⁺, Rb⁺, Cs⁺, [N(C₄H₉)₄]⁺, [PPh₄]⁺, [H₃N(C₄H₉)]⁺, [H₃N(C₄H₈)NH₃]²⁺, and [N(CH₃)₃(C₈H₁₇)]⁺. In more preferred embodiments, the cation is Na⁺, NH₄⁺, or an organic cation.

Conveniently, different meta-vanadate salts may be mixed to fine-tune the refractive index for a desired application while still forming uniform films. For instance, a first and a second metavanadate salt may be combined where the first metavanadate salt results in a film with a lower refractive index compared with the film obtainable by a formulation comprising the second metavanadate salt, and wherein the film obtainable by a formulation comprising the first and the second salt results in a film having a refractive index that lies between the refractive index of the films obtainable by a formulation comprising the first and the second metavanadate, respectively.

In some embodiments, the formulation comprises one or more metavanadate salts as defined above. In preferred embodiments, the formulation comprises a metavanadate salt as defined above. In other preferred embodiments, the formulation comprises two metavanadate salts. In other preferred embodiments, the formulation comprises three metavanadate salts. In even more preferred embodiments, the formulation comprises one or more metavanadates as defined above, wherein each metavanadate salt is selected from the group consisting of sodium metavanadate, potassium metavanadate, lithium metavanadate, and cesium metavanadate. In alternative preferred embodiments, the one or more metavanadate salt comprises an organic cation, such as, e.g. tetrabutylammonium metavanadate and ammonium metavanadate. In one embodiment, the formulation comprises a mixture of an organic metavanadate salt and an inorganic metavanadate salt, and a formulation medium, optionally wherein the formulation medium is a mixture of an organic solvent and water. In one embodiment, the formulation is a mixture of an organic solvent and water, wherein the ratio between the organic solvent and water is 1:1, preferably 1.5:1. In one embodiment, the formulation is a mixture of PGME and water, optionally wherein the ration between PGME and water is about 1.5 to 1.

In some embodiments, the weight ratio of the total amount of metavanadate salt in the formulation is in the range from 0.01 to 50 wt.-% based on the total mass of the formulation. In preferred embodiments, the weight ratio of the total amount of metavanadate salt in the formulation is in the range from 0.1 to 30 wt.-%. In even more preferred embodiments, the weight ration of the total amount of metavanadate salt in the formulation is in the range from 0.5 to 15 wt.-%.

In some embodiments the formulation medium is a solution medium and/or a dispersion medium. In preferred embodiments, the formulation medium is selected from water, alcohols, carboxylic acids, ethers, ketones, amides, sulfones, and mixtures thereof. In even more preferred embodiments, the formulation medium is selected from the list consisting of propylene glycol methyl ether, di(propylene glycol) methyl ether, propylene glycol methyl ether acetate, dimethyl sulfoxide, dimethylformamide, dimethylacetamide, propylene carbonate, propylene glycol, water, and mixtures thereof.

Typically, VO₂⁺ is the dominating species in the most acidic solutions. At a pH of about 3 to about 6, depending on the total concentration, the orange-colored decavanadate dominates. At the neutral pH range, also sometimes referred to as the “metavanadate” range, colorless mono-, di- and cyclic oligovanadate species exist. For instance, the species H₂VO₄⁻, H₂V₂O₇²⁻, V₄O₁₂⁴⁻, V₅O₁₅⁵⁻, often denoted as V1, V2, V4 and V5, respectively) carry a charge of −1 per vanadium, and in all cases, vanadium is tetrahedrally coordinated to oxygen. At a pH above 8, linear tetrameric (HV₄O₁₃⁵⁻ and V₄O₁₃⁶⁻) species form, together with the singly deprotonated dimer, HV₂O₇³⁻. The main species in alkaline solutions, however, are the monoprotonated monomer, HVO₄²⁻, and its dimer, V₂O₇⁴⁻. At very alkaline pH (above 12), the only existing species is the vanadate ion, VO₄³⁻

Conveniently, the pH of the vanadate derived aqueous formulation is controlled such that the metavanadate form predominates.

In some embodiments, the pH of the formulation as described above is between 6 and 11, preferably between 7 and 9. Formulation having a pH below 6 may result in films that absorb light in the violet-blue region of the visible spectrum, making these films appear red. Formulations having a pH above 11 may result in films that are micro-crystalline. Micro-crystalline films may scatter light and may result in films having a relatively low refractive index of n<1.47. Conveniently, the pH is measured using a pH-meter.

In some embodiments, the formulation further comprises (iii) one or more additive. Each additive individually may be selected from the group consisting of a wetting agent, a dispersion agent, an adhesion promoter, a polymer matrix, and a surfactant.

The presence of one or more additive in the formulation according to the invention may improve the properties of the optical metal oxide layer obtained or obtainable by said formulation such as e.g. material hardness, shrinkage, refractive index, transparency, absorbance, and haze suppression.

Preferred surfactants are surface active substances, which preferably include surface active metal oxides and/or surface-active organic compounds. Surface-active organic compounds may include nonionic surfactants, anionic surfactants, and ampholytic surfactants and they may be coordinating or non-coordinating.

Examples of nonionic surfactants include, polyoxyethylene alkyl ethers, such as polyoxyethylene lauryl ether, polyoxyethylene oleyl ether and 30 polyoxyethylene cetyl ether; polyoxyethylene fatty acid diester; polyoxyethylene fatty acid monoester; polyoxyethylene polyoxypropylene block polymer; acetylene alcohol; acetylene glycol; polyethoxylate of acetylene alcohol; acetylene glycol derivatives, such as polyethoxylate of acetylene glycol; fluorine-containing surfactants, for example, FLUORAD (trade name, manufactured by Sumitomo 3M Limited), MEGAFAC (trade name: manufactured by DIC Cooperation), SURFLON (trade name, 5 manufactured by Asahi Glass Co. Ltd); or organosiloxane surfactants, for example, KP341 (trade name, manufactured by Shin-Etsu Chemical Co., Ltd.), and the like. Examples of said acetylene glycol include 3-methyl-1-butyne-3-ol, 3-methyl-1-pentyn-3-ol, 3,6-dimethyl-4-octyne-3,6-diol, 2,4,7,9-tetramethyl-5-decyne-4,7-diol, 3,5-dimethyl-1-hexyne-3-ol, 2,5-dimethyl-3-10 hexyne-2,5-diol, 2,5-dimethyl-2,5-hexane-diol, and the like.

Examples of anionic surfactants include ammonium salt or organic amine salt of alkyl diphenyl ether disulfonic acid, ammonium salt or organic amine salt of alkyl diphenyl ether sulfonic acid, ammonium salt or organic amine 15 salt of alkyl benzene sulfonic acid, ammonium salt or organic amine salt of polyoxyethylene alkyl ether sulfuric acid, ammonium salt or organic amine salt of alkyl sulfuric acid, and the like.

Examples of amphoteric surfactants include 2-alkyl-N-carboxymethyl-N-20 hydroxyethyl imidazolium betaine, lauric acid amide propyl hydroxysulfone betaine, and the like.

Preferred surface-active metal oxides are selected from the list consisting of aluminum oxide, calcium oxide, silica, and zinc oxide. Such surface-active metal oxides are preferably present as fine powders, more preferably as nanoparticles, which are optionally surface treated.

Preferred surface-active organic compounds are surface-active non-polymeric compounds or surface-active polymeric organic compounds, wherein said surface-active non-polymeric compounds are preferably selected from the list consisting of alcohols, alkoxylates, aromatics, ketones, esters, modified urea, silanes, siloxanes and soap-based foam stabilizers, which are optionally functionalized and/or modified; and wherein said surface-active polymeric compounds are preferably selected from the list consisting of hydroxy polyesters, maleinate resins, polyacrylates, polyethers, polyester, polysilanes, silicone resins, and waxes, which are optionally functionalized and/or modified; and which are optionally present as copolymers. In a preferred embodiment, the surface-active organic compound is used as a solution.

Preferred silanes are polyether-modified silanes, polyester-modified silanes, and polyether-polyester-modified silanes. Preferred siloxanes are polyether-modified siloxanes, polyester-modified siloxanes, and polyether-polyester-modified siloxanes.

Preferred polyacrylates are modified polyacrylates, preferably silicone-modified polyacrylates, polyether macromer-modified polyacrylates, and silicone and polyether macromer-modified polyacrylates, which are optionally present as copolymers.

Preferred polysilanes are polyether-modified polysilanes (e.g. PEG-Silane 6-9), polyester-modified polysilanes, and polyether-polyester-modified polysilanes.

Preferred silicone resins are polyether-modified polysiloxanes, preferably polyether-modified polydialkylsiloxanes, more preferably polyether-modified polymethylalkylsiloxanes, and most preferably polyether-modified polydimethylsiloxanes and polyether-modified, hydroxy-functional polydimethylsiloxanes; polyester-modified polysiloxanes, preferably polydialkylsiloxanes, more preferably polyester-modified polymethylalkylsiloxanes, and most preferably polyester-modified polydimethylsiloxanes and polyester-modified, hydroxy-functional polydimethylsiloxanes; polyether-polyester-modified polysiloxanes, preferably polyether-polyester-modified polydialkylsiloxanes, more preferably polyether-polyester-modified polymethylalkylsiloxanes, and most preferably polyether-polyester-modified polydimethylsiloxanes and polyether-polyester-modified, hydroxy-functional polydimethylsiloxanes; epoxy functional polysiloxanes, preferably epoxy functional polydialkylsiloxanes, more preferably epoxy functional preferably epoxy functional polymethylalkylsiloxanes, and most polydimethylsiloxanes; acryl functional polysiloxanes, preferably acryl functional polydialkylsiloxanes, more acryl functional preferably polymethylalkylsiloxanes, and most preferably acryl functional polydimethylsiloxanes; polyether-modified, acryl functional polysiloxanes, preferably polyether-modified, acryl-functional polydialkylsiloxanes, more preferably polyether-modified, acryl-functional polymethylalkylsiloxanes, and most preferably polyether-modified, acryl-functional polydimethylsiloxanes; polyester-modified, acryl-functional polysiloxanes, preferably polyester-modified, acryl-functional polydialkylsiloxanes, more preferably polyester-modified, acryl-functional polymethylalkylsiloxanes, and most preferably polyester-modified, acryl-functional polydimethylsiloxanes; and aralkyl-modified polysiloxanes, preferably aralkyl-modified polydialkylsiloxanes, more preferably aralkyl-modified polymethylalkylsiloxanes, and most preferably aralkyl-modified polydimethylsiloxanes; which are optionally present as copolymers.

Preferred surfactants are commercially available from BYK-Chemie GmbH, Wesel, Germany and offered as surface additives. Preferred surfactants are DISPERBYK (hereafter “BYK”) surfactants selected from BYK-300, BYK-301, BYK-302, BYK-306, BYK-307, BYK-310, BYK-313, BYK-315 N, BYK- 320, BYK-322, BYK-323, BYK-325 N, BYK-326, BYK-327, BYK-329, BYK-330, BYK-331, BYK-332, BYK-333, BYK-342, BYK-345, BYK-346, BYK-347, BYK-348, BYK-349, BYK-350, BYK-352, BYK-354, BYK-355, BYK-356, BYK-358 N, BYK-359, BYK-360 P, BYK-361 N, BYK-364 P, BYK-366 P, BYK-368 P, BYK 370, BYK 375, BYK-377, BYK-378, BYK-381, BYK-390, BYK-392, BYK-394, BYK-399, BYK-2616, BYK-3400, BYK-3410, BYK-3420, BYK-3450, BYK-3451, BYK-3455, BYK-3456, BYK-3480, BYK-3481, BYK-3499, BYK-3550, BYK-3560, BYK-3565, BYK-3566, BYK-3750, BYK-3751, BYK-3752, BYK-3753, BYK-3754, BYK-3760, BYK-3761, BYK-3762, BYK-3763, BYK-3764, BYK-3770, BYK-3771, BYK-3780, BYK-3900 P, BYK 3902 P, BYK-3931 P, BYK 3932 P, BYK-3933 P, BYK-8020, BYK-8070, BYK-9890, BYK-DYNWET 800, BYK-S 706, BYK-S 732, BYK-S 740, BYK-S 750 N, BYK-S 760, BYK-S 780, BYK-S 782, BYK-SILCELAN 3700, BYK-SILCLEAN 3701, BYK-SILCLEAN 3710, BYK-SILCLEAN 3720, BYK-UV 3500, BYK-UV 3505, BYK-UV 3510, BYK-UV 3530, BYK-UV 3535, BYK-UV 3570, BYK-UV 3575, BYK-UV 3576; BYKETOL series such as BYKETOL-AQ, BYKETOL-OK, BYKETOL-PC, BYKETOL-SPECIAL, BYKETOL-WA, NANOBYK seleries such as NANOBYK-3603, NANOBYK-3605, NANOBYK-3620, NANOBYK-3650, NANOBYK-3652, and NANOBYK-3822.

The wetting and dispersion agents used in the present invention are additives, which provide both wetting and/or stabilizing effects for formulations containing fine solid particles. They result in a fine and homogenous distribution of solid particles in a formulation media, preferably liquid formulation media, and ensure long-term stability of such systems. The formulation media may comprise water and the entire range of organic solvents of varying polarity. Moreover, they result in an improved wetting of solids and prevent particles from flocculating by various mechanisms (e.g. by electrostatic effects, steric effects, etc.).

Preferably, the wetting and dispersion agents are organic polymers or organic copolymers having polar functional groups selected from amino groups; amide groups; carbamate groups; carbonate groups; acidic groups, preferably boric acid groups, boronic acid groups, carboxylic acid groups, sulfuric acid groups, sulfonic acid groups, phosphoric acid groups, phosphonic acid groups, and phosphinic acid groups; ester groups, preferably boric ester groups, boronic ester groups, carboxylic ester groups, sulfuric ester groups, sulfonic ester groups, phosphoric ester groups, phosphonic ester groups, and phosphinic ester groups; ether groups; hydroxy groups; keto groups; and urea groups; wherein the organic polymers or copolymers may be present as a conjugate, derivative and/or salt, preferably as a salt. Preferred salts are ammonium salts, alkyl ammonium salts, alkylol ammonium salts, or alkaline metal salts such as preferably Li, Na, K and Rb salts. The polar functional groups may be also referred to as pigment-affinic groups or as filler-affinic groups. In a preferred embodiment, the wetting and dispersion agent is used as a solution.

More preferably, the wetting and dispersion agents are organic polymers or organic copolymers selected from acrylates; amides; carboxylic acids; and esters; wherein the organic polymers or copolymers may be present as a conjugate, derivative and/or salt, preferably as a salt; and wherein they may be further functionalized with one or more polar functional group as described above. Preferred salts are ammonium salts, alkyl ammonium salts, alkylol ammonium salts, or alkaline metal salts such as preferably Li, Na, K, Cs, and Rb salts. In a preferred embodiment, the wetting and dispersion agent is used as a solution.

The wetting and dispersion agents may be present as a mixture, preferably as a mixture with a polysiloxane copolymer.

Preferred wetting and dispersing agents are commercially available from BYK-Chemie GmbH, Wesel, Germany. Preferred wetting and dispersing agents are ANTI-TERRA-202, ANTI-TERRA-203, ANTI-TERRA-204, ANTI-TERRA-205, ANTI-TERRA-210, ANTI-TERRA-250, ANTI-TERRA-U, ANTI-TERRA-U 80, ANTI-TERRA-U 100, BYK-151, BYK-153, BYK-154, BYK-155/35, BYK-156, BYK-220 S, BYK-1160, BYK-1162, BYK-1165, BYK-9076, BYK-9077, BYK-GO 8702, BYK-GO 8720, BYK-P 104, BYK-P 104 S, BYK-P 105, BYK-SYNERGIST 2100, BYK-SYNERGIST 2105, BYK-W 900, BYK-W 903, BYK-W 907, BYK-W 908, BYK-W 909, BYK-W 940, BYK-W 961, BYK-W 966, BYK-W 969, BYK-W 972, BYK-W 974, BYK-W 980, BYK-W 985, BYK-W 995, BYK-W 996, BYK-W 9010, BYK-W 9011, BYK-W 9012, BYKJET-9131, BYKJET-9132, BYKJET-9133, BYKJET-9142, BYKJET-9150, BYKJET-9151, BYKJET-9152, BYKJET-9170, BYKJET-9171, BYKUMEN, DISPERBYK, DISPERBYK-101 N, DISPERBYK-102, DISPERBYK-103, DISPERBYK-106, DISPERBYK-107, DISPERBYK-108, DISPERBYK-109, DISPERBYK-110, DISPERBYK-111, DISPERBYK-115, DISPERBYK-118, DISPERBYK-130, DISPERBYK-140, DISPERBYK-142, DISPERBYK-145, DISPERBYK-161, DISPERBYK-162, DISPERBYK-162 TF, DISPERBYK-163, DISPERBYK-163 TF, DISPERBYK-164, DISPERBYK-165, DISPERBYK-166, DISPERBYK-167, DISPERBYK-167 TF, DISPERBYK-168, DISPERBYK-168 TF DISPERBYK-169, DISPERBYK-170, DISPERBYK-171, DISPERBYK-174, DISPERBYK-180, DISPERBYK-181, DISPERBYK-182, DISPERBYK-184, DISPERBYK-185, DISPERBYK-187, DISPERBYK-190, DISPERBYK-190 BF, DISPERBYK-191, DISPERBYK-192, DISPERBYK-193, DISPERBYK-194 N, DISPERBYK-199, DISPERBYK-199 BF, DISPERBYK-2000, DISPERBYK-2001, DISPERBYK-2008, DISPERBYK-2009, DISPERBYK-2010, DISPERBYK-2012, DISPERBYK-2013, DISPERBYK-2014, DISPERBYK-2015, DISPERBYK-2015 BF, DISPERBYK-2018, DISPERBYK-2019, DISPERBYK-2022, DISPERBYK-2023, DISPERBYK-2025, DISPERBYK-2026, DISPERBYK-2030, DISPERBYK-2050, DISPERBYK-2055, DISPERBYK-2059, DISPERBYK-2060, DISPERBYK-2061, DISPERBYK-2062, DISPERBYK-2070, DISPERBYK-2080, DISPERBYK-2081, DISPERBYK-2096, DISPERBYK-2117, DISPERBYK-2118, DISPERBYK-2150, DISPERBYK-2151, DISPERBYK-2152, DISPERBYK-2155, DISPERBYK-2155 TF DISPERBYK-2157, DISPERBYK-2158, DISPERBYK-2159, DISPERBYK-2163, DISPERBYK-2163 TF, DISPERBYK-2164, DISPERBYK-2190, DISPERBYK-2200, DISPERBYK-2205, DISPERBYK-2290, DISPERBYK-2291, DISPERPLAST-1142, DISPERPLAST-1148, DISPERPLAST-1150, DISPERPLAST-1180, DISPERPLAST-I, and DISPERPLAST-P.

Preferred adhesion promoters are block copolymers, preferably high molecular weight block copolymers; copolymers with functional groups, preferably hydroxy-functional copolymers with acidic groups, styrene-ethylene/butylene-styrene block copolymer (SEBS) functionalized with maleic acid anhydride, carboxylated SEBS functionalized with maleic anhydride, SEBS functionalized with glycidyl methacrylate, polyolefin block copolymer functionalized with maleic acid anhydride, and ethylene octene copolymer functionalized with maleic anhydride; and polymers with functional groups, preferably polymers with acidic groups, and polypropylene functionalized with maleic anhydride. In a preferred embodiment, the adhesion promoter is used as a solution.

Preferred adhesion promoters are commercially available from BYK-Chemie GmbH, Wesel, Germany. Preferred adhesion promoters are BYK-4500, BYK-4509, BYK-4510, BYK-4511, BYK-4512, BYK-4513, SCONA TPKD 8102 PCC, SCONA TSIN 4013 GC, SCONA TSPOE 1002 GBLL, SCONA TPPP 2112 FA, SCONA TPPP 2112 GA, SCONA TPPP 8112 GA, SCONA TSKD 9103, SCONA TPPP 8112 FA, SCONA TPKD 8304 PCC, and SCONA TSPP 10213 GB.

Preferred polymer matrices are polymethyl methacrylate, polyvinylpyrrolidone, polycarbonate, polystyrene, polymethylpentene, and silicone.

In some embodiments, the one or more formulation media are solution media and/or dispersion media. In preferred embodiments, the one or more formulation media is selected from water, amides, aromatic hydrocarbons, non-aromatic hydrocarbons, alcohols, carboxylic acids, esters, ethers, ketones, diketones, lactones, and mixtures thereof. In particularly preferred embodiments, one formulation medium is water. In further particularly preferred embodiments, the formulation medium is water.

In a preferred embodiment of the present invention, the formulation is an ink formulation being suitable for inkjet printing. Typical requirements for ink formulations are surface tensions in the range from 20 mN/m to 30 mN/m and viscosities in the range from 5 mPa·s to 10 mPa·s.

### Method for Preparing the Formulation of the Present Invention

In another aspect, the present invention relates to a method of preparing the formulation of any one of the preceding claims, comprising at least the following step:
(X) mixing
(I) one or more metavanadate salts of formula (I) and/or (II);

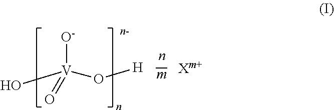

wherein X represents a cation,
m is 1, 2, or 3, preferably 1 or 2; and
n is an integer ≥2, optionally between 2 and 10 (in water), preferably n is 1;

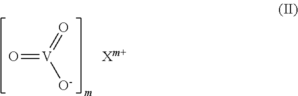

wherein X represents a cation,
m is 1, 2, or 3, preferably 1 or 2; and (II) a formulation medium.

Preferably, said cation is selected from the group consisting of ammonium cation, alkali metal cation, alkaline earth metal cation, and organic cation. More preferably, the cation is selected from the group consisting of Li⁺, Na⁺, NH₄⁺, K⁺, Rb⁺, Cs⁺, [N(C₄H₉)₄]⁺, [PPh₄]⁺, [H₃N(C₄H₉)]⁺, [H₃N(C₄H₈)NH₃]²⁺, and [N(CH₃)₃(C₈H₁₇)]⁺.

Even more preferably, said metavanadate salt is selected from one or more members of the group consisting of sodium metavanadate, potassium metavanadate, lithium metavanadate, cesium metavanadate, tetrabutylammonium metavanadate and ammonium.

Preferably, the total amount of metavanadate salt is in the range from 0.01 to 50 wt. %, based on the total mass of the formulation, preferably from 0.1 to 30 wt. %, more preferably 0.5 to 15 wt. %.

Preferably, the formulation medium is a solution medium and/or a dispersion medium.

More preferably, the formulation medium is selected from water, alcohols, carboxylic acids, ethers, ketones, amides, sulfones, and mixtures thereof.

Preferably, the formulation medium is selected from the list consisting of propylene glycol methyl ether, di(propylene glycol) methyl ether, propylene glycol methyl ether acetate, dimethyl sulfoxide, dimethylformamide, dimethylacetamide, propylene carbonate, propylene glycol, water, and mixtures thereof.

Preferably, the pH of the formulation is in the range from 6 to 11, preferably from 7 to 9.

Preferably, the formulation further comprises (iii) one or more additives selected from surfactants, wetting and dispersion agents, adhesion promoters, and polymer matrices.

### Method for Preparing Optical Metal Oxide Layer

In another aspect, there is provided a method for preparing an optical metal oxide layer, wherein the method comprises the following steps (a) to (c):
(a) providing a formulation wherein the formulation comprises:
   (i) one or more metavanadate salt according to formula (I) as defined herein above; and (ii) a formulation medium;
(b) applying the formulation to a surface of a substrate; and
(c) converting the formulation on the surface of the substrate to an optical metal oxide layer.

In a preferred embodiment of the present invention, the formulation provided in step (a) of the method for preparing an optical metal oxide layer is an ink formulation being suitable for inkjet printing. Typical requirements for ink formulations are surface tensions in the range from 20 mN/m to 30 mN/m and viscosities in the range from 5 mPa's to 10 mPa·s.

In a preferred embodiment of the method for preparing an optical metal oxide layer according to the present invention, the formulation is applied in step (b) to a surface of a substrate by a deposition method. A preferred deposition method is drop casting, coating, or printing. A more preferred coating method is spin coating, spray coating, slit coating, or slot-die coating. A more preferred printing method is flexo printing, gravure printing, inkjet printing, EHD printing, offset printing, or screen printing. Most preferred are spray coating and inkjet printing.

Depending on the specific problem to be solved, the formulation needs to be deposited either as a homogeneous, dense and thin layer covering the entire surface of the substrate by a coating method or the formulation needs to be deposited locally in a structured manner, thus requiring for a printing method.

Both, coating and printing methods require formulations to be formulated in an adequate manner to comply with the physico-chemical needs of the respective coating and printing method as well as to comply with certain needs regarding the surface of the substrate to be coated or printed.

Depending on e.g. solid content and trench volume, step (b) is conducted one or more times, such as, e.g. two, three, four, five, six times.

In a preferred embodiment of the method for preparing an optical metal oxide layer according to the present invention, the surface of the substrate is pre-treated by a surface cleaning process. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet cleaning process involving cleaning solvents (e.g. isopropanol (IPA)); wet etching processes involving hydrogen peroxide solutions (e.g. piranha solution, SC1, and SC2), choline solutions, or HF solutions; dry etching processes involving chemical vapor etching, UV/ozone treatments or glow discharge techniques (e.g. O₂ plasma etching); and mechanical processes involving brush scrubbing, fluid jet or ultrasonic techniques (sonification). The surface of the substrate can also be pre-treated by silanization or an atomic layer deposition (ALD) process. The pre-treatment of the surface of the substrate serves to modify the hydrophobicity/hydrophilicity of the surface. This can improve the adhesion and filling characteristics of the optical metal oxide layer on the surface of the substrate.

In a more preferred embodiment, a wet cleaning process involving cleaning solvents (e.g. isopropanol (IPA)) is combined with one or more of a wet etching process involving hydrogen peroxide solutions (e.g. piranha solution, SC1, and SC2), choline solutions, or HF solutions; dry etching process involving chemical vapor etching, UV/ozone treatments or glow discharge techniques (e.g. O₂ plasma etching); and mechanical process involving brush scrubbing, fluid jet or ultrasonic techniques (sonification).

In a most preferred embodiment, a wet cleaning process involving cleaning solvents (e.g. isopropanol (IPA)) is combined with a mechanical process involving brush scrubbing, fluid jet or ultrasonic techniques (sonification) and with a wet etching process involving hydrogen peroxide solutions (e.g. piranha solution, SC1, and SC2), choline solutions, or HF solutions;

In a preferred embodiment of the present invention, step (b) of the method for preparing an optical metal oxide layer is conducted several times in succession, preferably 2 to 20 times, more preferably 2 to 10 times, most preferably 2, 3, 4 or 5 times.

In a preferred embodiment of the method for preparing an optical metal oxide layer according to the present invention, the formulation is converted in step (c) on the surface of the substrate to an optical metal oxide layer by exposure to thermal treatment and/or irradiation treatment.

Preferred thermal treatment includes exposure to elevated temperatures up to 500° C. Thermal treatment is not limited to any specific thermal treatment methods or times. Depending on the type of substrate and formulation, a person skilled in the art is able to determine suitable thermal treatment methods and times.

Preferred irradiation treatment includes exposure to infrared (IR) light, visible (Vis) light and/or ultraviolet (UV) light. IR light has a wavelength of >800 nm. Visible light has a wavelength from 400 to 800 nm. UV light has a wavelength of <400 nm and may include EUV (extreme UV). Irradiation treatment is not limited to any specific irradiation treatment methods or times. Depending on the type of substrate and formulation, a person skilled in the art is able to determine suitable irradiation treatment methods and times.

In a more preferred embodiment of the method for preparing an optical metal oxide layer according to the present invention, the formulation is converted in step (c) on the surface of the substrate to an optical metal oxide layer by pre-baking (soft baking) at a temperature from 40 to 150° C., preferably from 50 to 120° C., more preferably from 60 to 100° C.; and then baking (hard baking, sintering or annealing) at a temperature from 150 to 600° C., preferably from 250 to 550° C., more preferably from 300 to 500° C.

Soft baking (also referred to as pre-baking) serves the purpose to remove volatile and low boiling components such as e.g. volatile and low boiling formulation media or additives from the drop casted, coated or printed films. Soft baking is preferably carried out for a period of 1 to 10 minutes. After soft-baking, layers of substrate adhering films of metal oxide precursor or metal oxide precursor mixtures are obtained. The films may still comprise residual formulation media or additives.

In an alternative more preferred embodiment of the method for preparing an optical metal oxide layer according to the present invention, soft-baking can be omitted so that the formulation is converted in step (c) on the surface of the substrate to an optical metal oxide layer directly by baking (hard baking, sintering or annealing) at a temperature from 150 to 600° C., preferably from 250 to 550° C., more preferably from 300 to 500° C.

Baking (hard baking, sintering or annealing) serves the purpose to convert the metal oxide precursor or metal oxide precursor mixture layers on the substrate into a metal oxide layer. Moreover, the final properties of the metal oxide layer may be adjusted by the baking treatment. Baking is preferably conducted for a period of 1 to 300 minutes, preferably 1 to 60 minutes to achieve a refractive index (RI) of >1.6.

Soft-baking and hard-baking may be conducted under ambient atmosphere or atmospheres with increased oxygen content in order to decompose unwanted organic components, which can lead to a lower activation energy when the metal oxide layers are formed.

Conveniently, solvent removal may trigger the condensation of oligomeric species to form 1D chain, same as the trenches of the substrate. The compatible dimensionality can aid in efficient deposition and organization of metavanadates into trenches in the substrate. Due to their dimensionality, the 1D meta-vanadate chains may show negligible tendency to form microcrystalline domains, which may reduce undesired light scattering at crystallite boundaries in the material film.

In a preferred embodiment of the method for preparing an optical metal oxide layer according to the present invention, the substrate is a patterned substrate comprising topographical features and the metal oxide forms a coating layer covering the surface of the substrate and filling said topographical features. As a result, the topographical features are filled and levelled by said metal oxide.

Preferred topographical features include, for example, gaps, grooves, surface relief gratings, trenches and vias. Topographical features may be distributed uniformly or non-uniformly over the surface of the substrate. Preferably, they are arranged as an array or grating on the surface of the substrate. It is preferred that the topographical features have different lengths, widths, diameters as well as different aspect ratios. It is preferred that said topographical features have an aspect ratio of 1:20 to 20:1, more preferably 1:10 to 10:1. The aspect ratio is defined as width of structure to its height (or depth). From the viewpoint of dimension, the depth of the topographical features is preferably in the range from 10 nm to 10 μm, more preferably 50 nm to 5 μm, and most preferably 100 nm to 1 μm.

It is also preferred that the topographical features are inclined at a certain angle, such as an angle from 10 to 80°, preferably from 20 to 60°, more preferably from 30 to 50°, most preferably about 40°. Such inclined topographical features are also referred to as slanted or blazed topographical features.

It may be also necessary to fill topographical features locally with optical metal oxide layer, either completely or to a certain level, but not to cover adjacent surfaces of the substrate, where no topographical features to be filled are available.

Hence, it is preferred that the method for preparing an optical metal oxide layer according to the present invention further comprises the following step (d):
(d) removing a portion of said optical metal oxide layer covering the top of the topographical features, thereby obtaining filled topographical features, wherein an overburden of the optical metal oxide layer on top of said topographical features is reduced, preferably to an overburden of between 0 to 100 nm, more preferably between 0 to 50, and most preferably between 0 to 20 nm.

Step (d) takes place after steps (a) to (c) of the method according to the present invention. Preferably, removing a portion of said optical metal oxide layer covering a top of the topography in step (d) is performed by using a surface cleaning process as described above. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet-etching processes involving hydrogen peroxide solutions (e.g. piranha solution, SC1, and SC2), choline solutions, or HF solutions; dry-etching processes involving chemical vapor etching, UV/ozone treatments or glow discharge techniques (e.g. O₂ plasma etching); and mechanical processes involving brush scrubbing, fluid jet or ultrasonic techniques.

The substrate is preferably a substrate of an optical device. Preferred substrates are made of inorganic or organic base materials, preferably inorganic base materials. Preferred inorganic base materials contain materials selected from the list consisting of ceramics, glass, fused silica, sapphire, silicon, silicon nitride, quartz, and transparent polymers or resins. The geometry of the substrate is not specifically limited, however, preferred are sheets or wafers.

In step (b) of the method for preparing an optical metal oxide layer, the formulation is applied on a surface of a substrate, wherein said surface may be either a surface of a base material of the substrate or a surface of a layer of a material being different from the base material of the substrate, wherein such layer has been formed prior to applying said formulation.

In this way, sequences of different layers (layer stacks) can be formed on top of one another. Such layer stacks may be also structured, wherein such structures typically have dimensions in the nanometer scale, at least with respect to diameter, width and/or aspect ratio.

### Use of the Formulation

In a third aspect, the invention relates to the use of a formulation for preparing an optical metal oxide layer, wherein the formulation comprises one or more metavanadate salts according to formula (1) as defined herein above, and a formulation medium.

### Optical Device

In a fourth aspect, there is provided an optical device comprising an optical metal oxide layer, which is obtainable or obtained by the method for preparing an optical metal oxide layer according to the present invention as described above. It is preferred that the optical device is an augmented reality (AR) and/or virtual reality (VR) device.

The present invention is further illustrated by the examples following hereinafter which shall in no way be construed as limiting. The skilled person will acknowledge that various modifications, additions and alternations may be made to the invention without departing from the spirit and scope of the invention as defined in the appended claims.

### EXAMPLES

Sodium metavanadate, ammonium metavanadate, cesium metavanadate, vanadium oxide, tetrabutylammonium hydroxide and all solvents were purchased from Sigma Aldrich and used without further purification, unless differently mentioned elsewhere. Lithium metavanadate was purchased from Alfa Aesar and used without further purification. Potassium metavanadate was purchased from Thermo Scientific and used without further purification.

### Analytics and Measurement Methods

Ellipsometry was used to determine layer thickness, refractive index (n) and absorption index (k) of a metal oxide layer. Measurements were performed using an ellipsometer M2000V(I) SE by J. A. Woollam and three different angles of incidence (65°, 70°, 75°), averaged over five spots. The measurement data was analyzed with software CompleteEase from J. A. Woolam applying a Gen-Osc fitting model with three fitted gaussian oscillators, for obtaining refractive indices (n) as well as absorption indices (k). The optical constants were averaged from five different points measured on the sample either after soft bake or after hard bake.

Optical spectra of any sheets and substrates being either coated or uncoated by metal oxide layers described in the present invention were recorded using UV/Vis/NIR-spectrophotometer Cary 7000 from Agilent with UMA-setup. Measurements were conducted using dual beam mode, a scan speed of 600 nm/min and a spectral band width of 4 nm, non-polarized light and applying a spectral window from 350 nm to 700 nm. Transmission measurements were conducted with an angle of incidence of 6° versus surface normal of the sample. The detector was aligned 180° to light incidence. Reflection measurements were conducted with an angle of incidence of 6° versus surface normal of the sample, the detector angle amounted to 12° versus incidence of light. The absorption of the samples was calculated using Equation 1, where A stands for the absorption of the coated sample, R stands for the reflection and T for the transmission of the sample.

$$A = 1 - ( R + T ) \qquad Equation 1$$

SEM images were recorded using a Magellan 400L by ThermoFisher.

Substrate coating, usually wafers, was done using a spin coater (Ossila L2001A) from Suess. The spin coating process using planar substrates was as follows: deposition of 1.0 ml of the coating onto static quartz wafers followed by a spinning interval of 10 seconds at 2000 RPM. After spin coating, the coated substrates underwent pre-baking at 100° C. for 1 minutes for driving out solvent residues, subsequently followed by baking at elevated temperatures. The coated layers were baked at 150° C., 200° C., 300° C., 400° C. and 500° C. for 10 minutes unless stated otherwise. Pre-baking as well as layer baking were performed using high temperature IKA C-MAG HS 7 hotplates allowing for reaching temperatures of up to 500° C. Aforementioned conditions and parameters apply to all following experimental examples unless other conditions are explicitly mentioned elsewhere.

Usually, quartz and/or silicon wafers, both 2″ in diameter, were used throughout all coating experiments where flat and non-structured carriers for metal oxides were required (e.g. spectroscopic and ellipsometry measurements).

Structured substrates, usually silicon wafers, were used as square-shaped dies with edge length of 1.8 cm. The wafer dies were cut and cleaved from a parent wafer, typically having a diameter of 8″. The structures were created and arranged in a layer stack composed of SiO₂/SiNₓ being deposited onto the wafer surface. Dimensions of the structures (e.g. cross-section width and length of trenches) referred to the architecture of Sematech mask 854.

Usually, however not limited hereto, the cross-sectional cleaves perpendicular to trench arrays providing a width of 40 nm to 50 nm were used as trench structures of primary interest to investigate their filling behavior by the wet-chemically coated metal oxide precursors and/or metal oxides received upon thermal conversion of the said metal oxide precursors. Besides to aforementioned, cross-sections of arrays of trenches having widths of 100 nm and 150 nm where used to investigate trench filling by metal oxides, too.

Structured wafer dies were, unless otherwise mentioned, coated by spin coating. For that purpose, the coating formulation, typically a volume between 0.1 ml per die, was pipetted and casted onto wafer's surface. The formulation was allowed to spread and settle on the surface for one minute, followed by a final spin-off step at 2,000 rpm for further 10 seconds. The soft bake and hard conditions of structured wafer dies was chosen similar or identical to those already mentioned for flat substrates.

Usually, quartz and/or silicon wafers, both 2″ in diameter, were used throughout all coating experiments where flat and non-structured carriers for metal oxides were required (e.g. spectroscopic and ellipsometry measurements).

### Metavanadate Formulations Example 1

Sodium metavanadate (NaVO₃) was dissolved 4 wt % in water by heating.

1 mL of the solution was deposited onto silicon or fused silica substrates and spin-coated at 2000 RPM for 10 seconds. The coated substrates were then pre-baked at 100° C. for 1 minute followed by a bake at 150° C. unless stated otherwise for 10 minutes.

The ellipsometry data of the coated silicon substrate is shown in Table 1.

TABLE 1
Ellipsometry data of Example 1.

| Bake temperature [° C.] | 150 | 200 | 300 | 400 | 500 |
|---|---|---|---|---|---|
| n at 520 nm | 1.8 | 1.81 | 1.85 | 1.84 | 1.54 |
| k at 460 nm | 1.4E−6 | 5.1E−7 | 1.5E−6 | 2.0E−3 | 1.6E−1 |

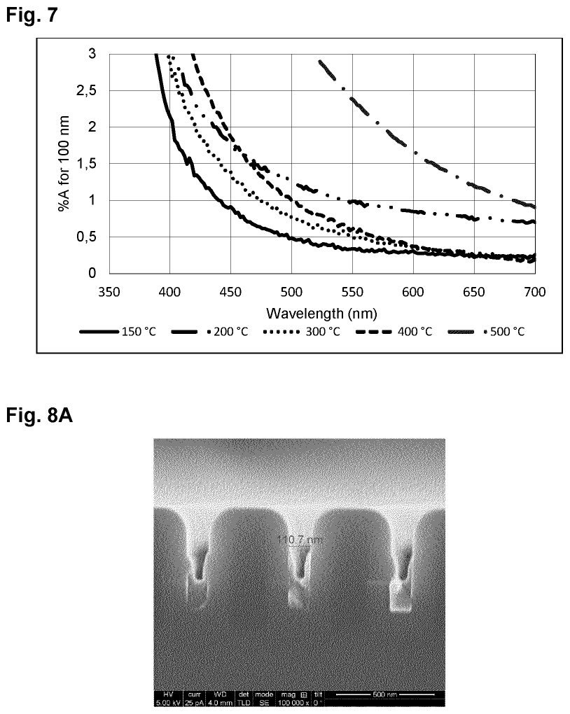

FIG. 7 shows the UV/Vis absorption spectra of the coated fused silica substrate showing the dependencies on processing temperature, normalized to a film of thickness of 100 nm.

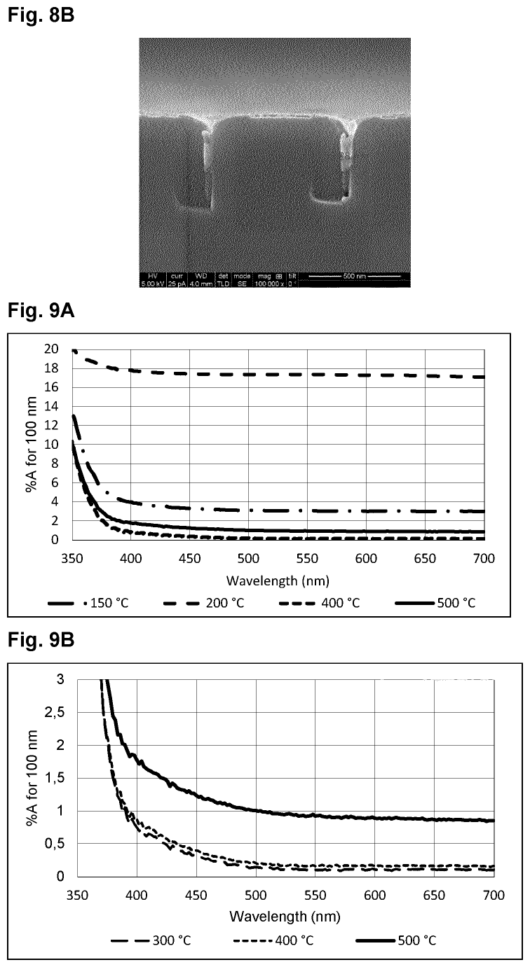

FIGS. 8A and 8B show SEM images of the coated trenched silicon nitride substrate showing the trench filling behavior.

### Example 2

Lithium metavanadate (LiVO₃) was dissolved in water (3.47 wt %) by heating. One mL of the solution was deposited onto silicon or fused silica substrates and spin-coated at 2000 rpm for 10 seconds. The coated substrates were then pre-baked at 100° C. for 1 minute followed by a bake at 150° C. unless stated otherwise for 10 minutes.

The ellipsometry data of the coated silicon substrate is shown in Table 2.

TABLE 2
Ellipsometry data of Example 2.

| Bake temperature [° C.] | 150 | 200 | 300 | 400 | 500 |
|---|---|---|---|---|---|
| n at 520 nm | 1.56 | 1.56 | 1.57 | 1.56 | 1.56 |
| k at 460 nm | 7.4E−4 | 4.3E−3 | 3.2E−3 | 7.3E−3 | 7.3E−3 |

FIGS. 9A and 9B show the UV/Vis absorption spectra of the coated fused silica substrate showing the dependencies on processing temperature, normalized to a film of thickness of 100 nm.

### Example 3

Lithium metavanadate (LiVO₃) was dissolved in 40:60 mixture of water:propylene glycol methyl ether (3.47 wt %) by heating.

One mL of the solution was deposited onto silicon or fused silica substrates and spin-coated at 2000 rpm for 10 seconds. The coated substrates were then pre-baked at 100° C. for 1 minute followed by a bake at 150° C. for 10 minutes.

The ellipsometry data of the coated silicon substrate is shown in Table 3.

TABLE 3
Ellipsometry data of Example 3.

| Bake temperature [° C.] | 150 |
|---|---|
| n at 520 nm | 1.57 |
| k at 460 nm | 2.9E−2 |

### Example 4

Ammonium metavanadate (NH₄VO₃) was dissolved in water (4 wt %) by heating.

One mL of the solution was deposited onto silicon or fused silica substrates and spin-coated at 2000 rpm for 10 seconds. The coated substrates were then pre-baked at 100° C. for 1 minute followed by a bake at 150° C. unless stated otherwise for 10 minutes.

The ellipsometry data of the coated silicon substrate is shown in Table 4.

TABLE 4
Ellipsometry data of Example 4.

| Bake temperature [° C.] | 150 | 200 | 300 | 400 | 500 |
|---|---|---|---|---|---|
| n at 520 nm | 2.28 | 2.55 | 2.62 | 2.41 | 2.33 |
| k at 460 nm | 1.9E−1 | 2.5E−1 | 4.6E−1 | 4.3E−1 | 4.1E−1 |

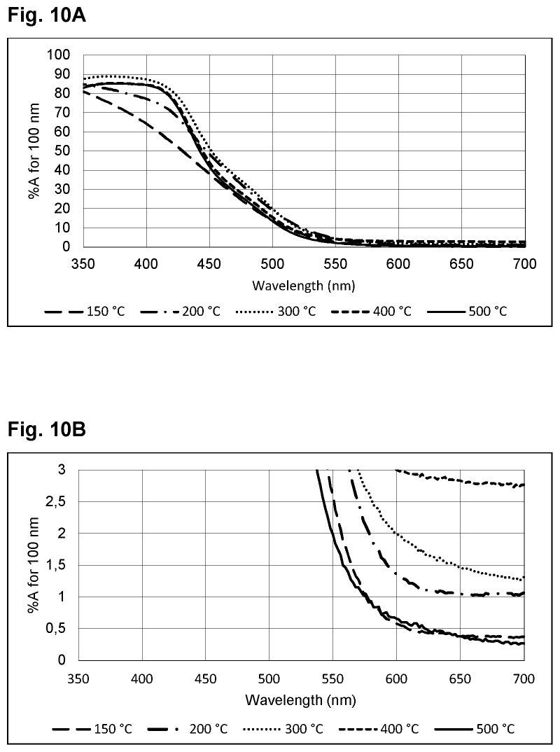

FIGS. 10A and 10B show the UV/Vis absorption spectra of the coated fused silica substrate showing the dependencies on processing temperature, normalized to a film of thickness of 100 nm.

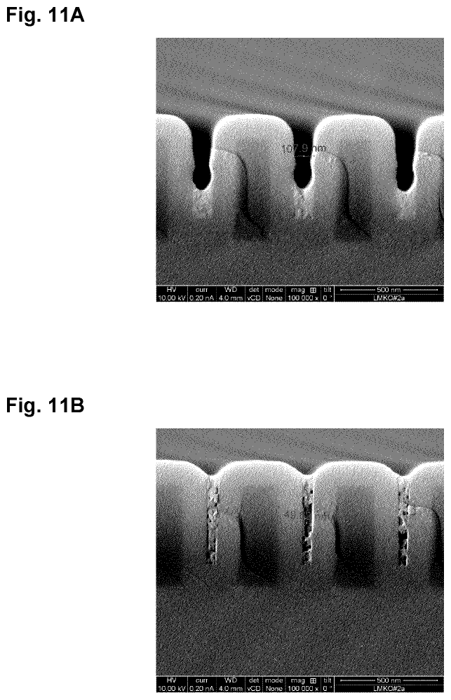

FIGS. 11A and 11B show SEM images of the coated trenched silicon nitride substrate showing the trench filling behavior.

### Example 5

Potassium metavanadate (KVO₃) was dissolved in water to a concentration of 4.5 wt % by heating.

One ml of the solution was deposited into silicon or fused silica substrates and spin-coated at 2000 rpm for 10 seconds. The coated substrates were then pre-baked at 100° C. for 1 minute followed by a bake at 150° C. unless stated otherwise for 10 minutes.

The ellipsometry data of the coated silicon substrate is shown in Table 5.

TABLE 5
Ellipsometry data of Example 5.

| | Bake temperature [° C.] | | | | |
|---|---|---|---|---|---|
| | 150 | 200 | 300 | 400 | 500 |
| n at 520 nm | 1.72 | 1.73 | 1.89 | 1.91 | 2.29 |
| k at 460 nm | 2.2E−5 | 2.2E−03 | 4.2E−2 | 8.2E−2 | 9.7E−1 |

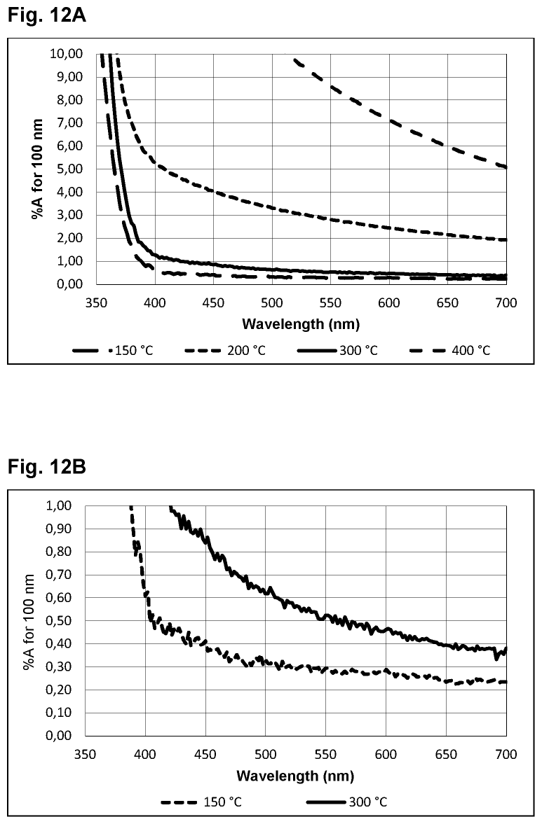

FIGS. 12A, 12B show the UV/Vis absorption spectra of the coated fused silica substrate showing the dependencies on processing temperature, normalized to a film of thickness of 100 nm.

### Example 6

Cesium metavanadate (CsVO₃) was dissolved in water to a concentration of 7.6 wt % by heating.

One mL of the solution was deposited onto silicon or fused silica substrates and spin-coated at 2000 rpm for 10 seconds. The coated substrates were then pre-baked at 100° C. for 1 minute followed by a bake at 150° C. unless stated otherwise for 10 minutes.

The ellipsometry data of the coated silicon substrate is shown in Table 6.

TABLE 6
Ellipsometry data of Example 6.

| | Bake temperature [° C.] | | | | |
|---|---|---|---|---|---|
| | 150 | 200 | 300 | 400 | 500 |
| n at 520 nm | 1.73 | 1.75 | 1.8 | 1.77 | 1.9 |
| k at 460 nm | 8.2E−5 | 1.0E−04 | 4.0E−5 | 2.7E−4 | 9.2E−2 |

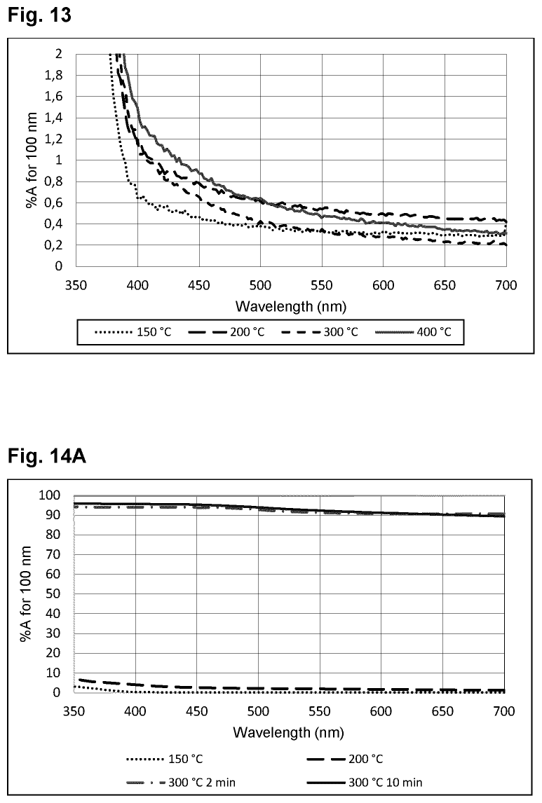

FIG. 13 shows the UV/Vis absorption spectra of the coated fused silica substrate showing the dependencies on processing temperature, normalized to a film of thickness of 100 nm.

### Example 7

Tetrabutylammonium metavanadate ((C₄H₉)₄NVO₃) was dissolved in propylene glycol methyl ether to a concentration of 11.2 wt % by stirring.

100 μL of the solution was deposited onto silicon or fused silica substrates and spin-coated at 2000 rpm for 10 seconds. The coated substrates were then pre-baked at 100° C. for 1 minute followed by a bake at 150° C. unless stated otherwise for 10 minutes.

The ellipsometry data of the coated silicon substrate is shown in Table 7.

TABLE 7
Ellipsometry data of Example 7.

| | Bake temperature [° C.] | | | | |
|---|---|---|---|---|---|
| | 150 | 200 | 300 | 400 | 500 |
| n at 520 nm | 1.73 | 1.75 | 1.8 | 1.77 | 1.9 |
| k at 460 nm | 1.6E−3 | 1.7E−02 | 2.3E−9 | 7.1E−27 | 1.0E−11 |

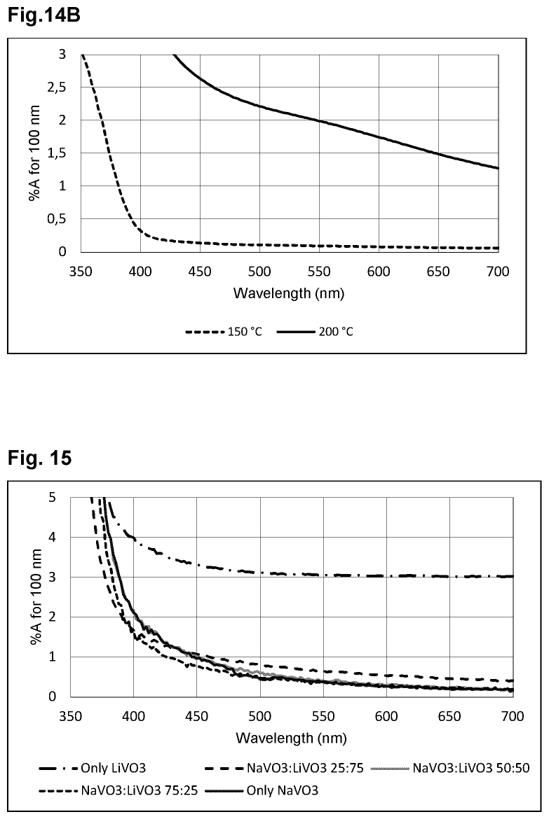

FIGS. 14A and 14B show the UV/Vis absorption spectra of the coated fused silica substrate showing the dependencies on processing temperature, normalized to a film of thickness of 100 nm.

### Example 8

A mixture of sodium metavanadate (NaVO₃) and lithium metavanadate (LiVO₃) were dissolved in water by heating such that the total concentration of VO₃⁻; is 0.34 M. 1 mL of the solution was deposited onto silicon or fused silica substrates and spin-coated at 2000 RPM for 10 seconds. The coated substrates were then pre-baked at 100° C. for 1 minute followed by a bake at 150° C. for 10 minutes.

Ellipsometry measurements of the coated silicon substrate show the following optical parameters:

| | Molar ratio NaVO₃:LiVO₃ | | | | |
|---|---|---|---|---|---|
| | 0:100 | 25:75 | 50:50 | 75:25 | 100:0 |
| n at 520 nm | 1.56 | 1.56 | 1.75 | 1.77 | 1.80 |
| k at 460 nm | 7.5E−4 | 5.8E−4 | 5.8E−6 | 3.6E−6 | 2.3E−6 |

FIG. 15 shows the UV/vis spectroscopy of the coated fused silica substrate shows the following absorption curve, normalized to a film of thickness 100 nm.

### Example 9

A mixture of sodium metavanadate (NaVO₃) and potassium metavanadate (KVO₃) were dissolved in water by heating such that the total concentration of VO₃⁻ is 0.34 M. 1 mL of the solution was deposited onto silicon or fused silica substrates and spin-coated at 2000 RPM for 10 seconds. The coated substrates were then pre-baked at 100° C. for 1 minute followed by a bake at 150° C. for 10 minutes.

Ellipsometry measurements of the coated silicon substrate show the following optical parameters:

| | Molar ratio NaVO₃:KVO₃ | | | | |
|---|---|---|---|---|---|
| | 0:100 | 25:75 | 50:50 | 75:25 | 100:0 |
| n at 520 nm | 1.66 | 1.82 | 1.80 | 1.85 | 1.80 |
| k at 460 nm | 2.2E−6 | 2.5E−2 | 2.4E−6 | 4.6E−3 | 2.3E−6 |

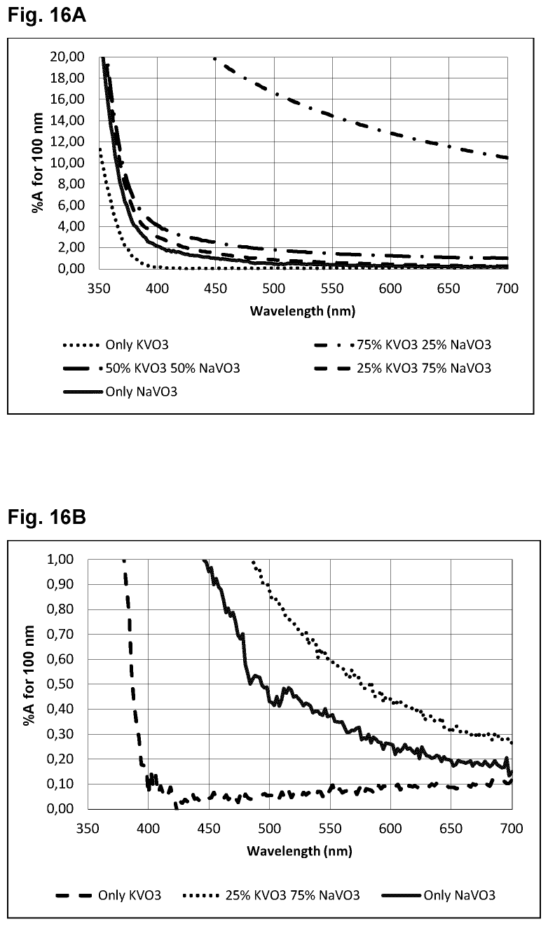

FIGS. 16A, 16B show the UV/vis spectroscopy of the coated fused silica substrate shows the following absorption curve, normalized to a film of thickness 100 nm. Namely FIG. 16B is an enlarged view of FIG. 16A.

1. A formulation for preparing an optical metal oxide layer, wherein the formulation comprises at least:
(i) an oligomer of one or more metavanadate salts, said oligomer is represented by formula I; 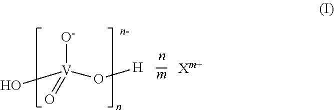
wherein X represents a cation,
m is 1, 2, or 3,
n is an integer >2, optionally between 2 and 10 (in water); and
(ii) a formulation medium.

2. The formulation according to claim 1, wherein the cation X is independently of each other, at their occurrence, selected from the group consisting of ammonium cation, alkali metal cation, alkaline earth metal cation, and organic cation.

3. The formulation according to claim 2, wherein the cation is selected from the group consisting of Li⁺, Na⁺, NH₄⁺, K⁺, Rb⁺, Cs⁺, [N(C₄H₉)₄]⁺, [PPh₄]⁺, [H₃N(C₄H₉)]⁺, [H₃N(C₄H₈)NH₃]²⁺, and [N(CH₃)₃ (C₈H₁₇)]⁺.

4. The formulation according to claim 1, wherein said one or more metavanadate salts are selected from the group consisting of sodium metavanadate, potassium metavanadate, lithium metavanadate, cesium metavanadate, tetrabutylammonium metavanadate and ammonium metavanadate.

5. The formulation according to claim 1, wherein the total amount of metavanadate salt is in the range from 0.01 to 50 wt. %, based on the total mass of the formulation.

6. The formulation according to claim 1, wherein the formulation medium is a solution medium and/or a dispersion medium.

7. The formulation according to claim 1, wherein the formulation medium is selected from water, alcohols, carboxylic acids, ethers, ketones, amides, sulfones, and mixtures thereof.

8. The formulation according to claim 1, wherein the formulation medium is selected from the list consisting of propylene glycol methyl ether, di(propylene glycol) methyl ether, propylene glycol methyl ether acetate, dimethyl sulfoxide, dimethylformamide, dimethylacetamide, propylene carbonate, propylene glycol, water, and mixtures thereof.

9. The formulation according to claim 1, wherein the pH of the formulation is in the range from 6 to 11.

10. The formulation according to claim 1, wherein the formulation further comprises (iii) one or more additives selected from surfactants, wetting and dispersion agents, adhesion promoters, and polymer matrices.

11. A method of preparing the formulation of claim 1, comprising at least the following step:
(X) adding;
(I) one or more metavanadate salts of formula (I) and/or (II); 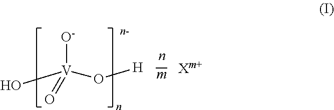
X represents a cation,
m is 1, 2, or 3; and
n is an integer ≥2, optionally between 2 and 10 (in water); 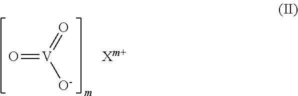
X represents a cation,
m is 1, 2, or 3; and
(II) a formulation medium.

12. (canceled)

13. A method for preparing an optical metal oxide layer comprising the following steps (a) to (c):
(a) providing a formulation according to claim 1;
(b) applying the formulation to a surface of a substrate; and
(c) converting the formulation on the surface of the substrate to an optical metal oxide layer.

14. The method according to claim 13, wherein in step (b) the formulation is applied to a surface of a substrate by a deposition method.

15. The method according to claim 13, wherein in step (c) the formulation is converted on the surface of the substrate to an optical metal oxide layer by exposure to thermal treatment and/or irradiation treatment.

16. The method according to claim 13, wherein in step (c) the formulation is converted on the surface of the substrate to an optical metal oxide layer by pre-baking at a temperature from 40 to 130° C.; and then baking at a temperature from 100 to 600° C.

17. The method according to claim 13, wherein the substrate is a patterned substrate comprising topographical features on the surface thereof.

18. An optical device comprising an optical metal oxide layer, which is obtainable by the method according to claim 13.

19. An optical device comprising an optical metal oxide layer, which is prepared by using the formulation according to claim 1.

20. The method according to claim 11, wherein the pH of the formulation is in the range from 6 to 11.

21. The formulation according to claim 1, wherein the pH of the formulation is in the range from 7 to 9.
